(19) United States
(12) Patent Application Publication
(10) Pub. No.: US 2016/0212675 A1
(43) Pub. Date: Jul. 21, 2016

(54) COMMUNICATION SYSTEM OF AVN FOR VEHICLE AND METHOD OF WIRELESS COMMUNICATION FOR THE SAME

(71) Applicant: Hyundai Motor Company, Seoul (KR)

(72) Inventor: Hyun Woo Choi, Gunpo (KR)

(21) Appl. No.: 14/810,506

(22) Filed: Jul. 28, 2015

(30) Foreign Application Priority Data
Jan. 21, 2015 (KR) 10-2015-0009987

(51) Int. Cl. H04W 36/32; H04L 29/08; H04W 36/08

(52) U.S. Cl. CPC H04W 36/32; H04W 36/08; H04L 67/12

(57) ABSTRACT

A wireless communication method for an audio-video-navigation (AVN) device of a vehicle includes: receiving position information of an estimated target base station, which is estimated based on navigation path information; receiving a handover command; comparing the position information of the estimated target base station to position information of the AVN device of the vehicle upon receiving the handover command; determining whether a first distance from the estimated target base station to the AVN device of the vehicle is within a threshold distance; requesting pre-sending with respect to the estimated target base station when the first distance is within the threshold distance; synchronizing with the estimated target base station; and generating a confirmation signal in response to the handover command.

### CROSS-REFERENCE TO RELATED APPLICATION

This application claims the benefit of and priority to Korean Patent Application No. 10-2015-0009987, filed on Jan. 21, 2015, which is hereby incorporated by reference as if fully set forth herein.

### BACKGROUND OF THE DISCLOSURE

1. Technical Field

The present disclosure relates generally to a wireless communication method of a vehicle using a communication network, and more particularly, to a communication system of an audio-video-navigation (AVN) device for a vehicle and a method of wireless communication for the same, for improving communication service quality of a moving vehicle.

2. Discussion of the Related Art

Recently, technology for connecting a vehicle to a mobile communication network (e.g., a cellular communication network) has been developed, enabling the vehicle itself to be used as a smart device, as well as a telematics service. According to such technology, known as “connected car technology,” information communication technology is associated with a vehicle to enable bidirectional Internet, a mobile service, and so on in the vehicle. For example, a vehicle can be remotely started or remotely turned on from an external source, and a driver can receive information regarding weather, news, and so on in real-time. In addition, the user can use various contents such as an image, music, and so on in real-time and can perform map searching, phone calls, and so on through voice.

In order to support a mobile communication network service, a car with connected car technology installed therein needs handover or handoff technology that reflects mobility of the connected car. Handover or handoff technology refers to a function in which a mobile terminal that is engaged or is transmitting and receiving data is automatically synchronized with a new channel of an adjacent enhanced NodeB (eNB) so as to continuously maintain a transceiving state upon deviating from a cell boundary of a corresponding eNB and moving to a cell boundary of the adjacent eNB.

However, when a mobile terminal is synchronized with the new channel, handover interrupt time occurs (about 15 ms), in which communication with any eNB is interrupted. Additionally, the handover interrupt time accumulates, and delay of a communication service occurs. Accordingly, there exists a need to overcome the communication service delay in order to enhance the quality of connected car technology.

### SUMMARY OF THE DISCLOSURE

Accordingly, the present disclosure is directed to a communication system for an audio-video-navigation (AVN) device of a vehicle and a wireless communication method thereof that substantially obviates one or more problems due to limitations and disadvantages of the related art.

An object of the present disclosure is to provide a communication system for an AVN device of a vehicle and a wireless communication method thereof, for overcoming a problem in terms of delaying data during handover of a vehicle.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a wireless communication method for an audio-video-navigation (AVN) device of a vehicle using a mobile communication network includes: receiving position information of an estimated target base station, which is estimated based on navigation path information; receiving a handover command; comparing the position information of the estimated target base station to position information of the AVN device of the vehicle upon receiving the handover command; determining whether a first distance from the estimated target base station to the AVN device of the vehicle is within a threshold distance; requesting pre-sending with respect to the estimated target base station when the first distance is within the threshold distance; synchronizing with the estimated target base station; and generating a confirmation signal in response to the handover command.

Furthermore, according to embodiments of the present disclosure, a wireless communication method for an audio-video-navigation (AVN) device of a vehicle using a mobile communication network includes: estimating, by a communication network provider server, position information of an estimated target base station based on navigation path information of the AVN device of the vehicle; generating, by the communication network provider server, a handover command using a signal level report of the AVN device of the vehicle; comparing, by the AVN device of the vehicle, the position information of the estimated target base station to position information of the AVN device of the vehicle upon receiving the handover command; determining, by the AVN device of the vehicle, whether a first distance from the estimated target base station to the AVN device of the vehicle is within a threshold distance; requesting, by the AVN device of the vehicle, pre-sending with respect to the estimated target base station when the first distance is within the threshold distance; synchronizing, by the AVN device of the vehicle, with the estimated target base station; and generating, by the AVN device of the vehicle, a confirmation signal in response to the handover command.

Furthermore, according to embodiments of the present disclosure, an audio-video-navigation (AVN) communication system for a vehicle using a mobile communication network includes: a communication network provider server i) estimating position information of an estimated target base station based on navigation path information and ii) generating a handover command using a signal level report; and an AVN device of the vehicle i) comparing the position information of the estimated target base station to position information of the AVN device of the vehicle upon receiving the handover command, ii) determining whether a first distance from the estimated target base station to the AVN device of the vehicle is within a threshold distance, iii) requesting pre-sending with respect to the estimated target base station when the first distance is within the threshold distance, iv) synchronizing with the estimated target base station, and v) generating a confirmation signal in response to the handover command.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a block diagram illustrating an audio-video-navigation (AVN) communication system for a vehicle according to embodiments of the present disclosure;

FIG. 2 is a diagram for explanation of navigation path information (NPI) and position information of an estimated target eNB shown in FIG. 1;

FIGS. 3A to 3C are diagrams for explanation of an operation of an AVN communication system for a vehicle at the point P illustrated in FIG. 2 according to embodiments of the present disclosure;

FIGS. 4A to 4C are diagrams for explanation of an operation of an AVN communication system for a vehicle around the point P illustrated in FIG. 2 according to a Comparative Example of the present disclosure; and

FIG. 5 is a flowchart for explanation of an operation of the vehicle AVN communication system of FIG. 1.

### DETAILED DESCRIPTION OF THE EMBODIMENTS

Hereinafter, an audio-video-navigation (AVN) system for a vehicle according to the present disclosure will be described in detail with reference to the accompanying drawings. In addition, the suffixes “module” and “unit” of elements herein are used for convenience of description and thus can be used interchangeably and do not have any distinguishable meanings or functions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that an AVN device, as referred to herein, includes a memory and a processor, as would be understood by a person of ordinary skill in the art. The memory is configured to store program instructions, and the processor is specifically programmed to execute the program instructions to perform one or more processes which are described further below.

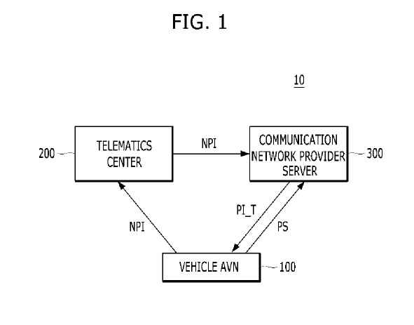

Referring now to the disclosed embodiments, FIG. 1 is a block diagram illustrating an AVN communication system for a vehicle according to embodiments of the present disclosure.

As shown in FIG. 1, the AVN communication system 10 for a vehicle may include an AVN device of the vehicle (alternatively “vehicle AVN” or, simply, “AVN”) 100, a telematics center 200, and a communication network provider server 300.

The vehicle AVN 100 may be installed in a vehicle, may control hardware such as a display, a touchscreen, a speaker, and so on according to a driver's request, and execute music, video, or navigation programs. In addition, the vehicle AVN 100 may control a vehicle controller (not shown) to perform an operation of charging, air conditioning, or other vehicle function according to an external remote control request.

The vehicle AVN 100 may be a terminal that pre-joins and is pre-registered with a specific mobile communication network service, and may wirelessly transmit and receive data to and from each of the telematics center 200 and the communication network provider server 300 using a mobile communication network managed by a communication network provider that provides the mobile communication network service. For example, the mobile communication network refers to a communication network for supporting mobile communication standards such as 3rd-generation (3G), long term evolution (LTE), 5G, and so on. That is, the vehicle AVN 100 may allow bidirectional Internet, a mobile service, and so on in a vehicle using connected car technology.

Since a vehicle including the vehicle AVN 100 installed therein moves at high speed, the vehicle AVN 100 supports handover or handoff that reflects mobility. The handover (or the handoff) refers to a function in which the vehicle AVN 100 that is transmitting and receiving data is automatically synchronized with a new channel of an adjacent eNB so as to continuously maintain a transceiving state upon deviating from a cell boundary of a current corresponding eNB and moving to a cell boundary of the adjacent eNB.

In order to prevent data delay during handover, the vehicle AVN 100 may generate navigation path information (NPI) and transmit the NPI to the telematics center 200. The NPI refers to information about a path, which is obtained by inputting a destination to a navigation program of the vehicle AVN 100 by a user and determined to guide movement to the destination from a current position.

The telematics center 200 is a server for providing a telematics service and may collect information required by the user and transmit the information to the vehicle AVN 100 or may transmit information received from the vehicle AVN 100 to the communication network provider server 300 or a corresponding organization (e.g., an insurance company or an emergency medical center).

The telematics center 200 may transmit the NPI received from the vehicle AVN 100 to the communication network provider server 300 identified through unique information of the vehicle AVN 100. The unique information may contain information about a type of a communication network service to which the vehicle AVN 100 transmitting the NPI subscribes and is registered with.

The communication network provider server 300 is a server that manages a mobile network service used by the vehicle AVN 100, and may generate position information PI_T of an estimated target eNB as a target eNB to be estimated to be synchronized with the vehicle AVN 100 according to the NPI and transmit the position information PI_T to the vehicle AVN 100.

In a data communication procedure to which handover technology is applied, a base station (or an enhanced NodeB (eNB)) may be classified into a source eNB and a target eNB. The source eNB is an eNB that is currently connected to the vehicle AVN 100 and relays data communication between the communication network provider server 300 and the vehicle AVN 100 and the target eNB is an eNB that is to be connected to the vehicle AVN 100 through a handover procedure.

The vehicle AVN 100 may generate a pre-sending request PS using the position information PI_T of the estimated target eNB and current position information of a vehicle including the vehicle AVN 100 installed therein. The pre-sending request PS is a signal that requests pre-downloading of the same data as data being currently downloaded from a source eNB by the vehicle AVN 100.

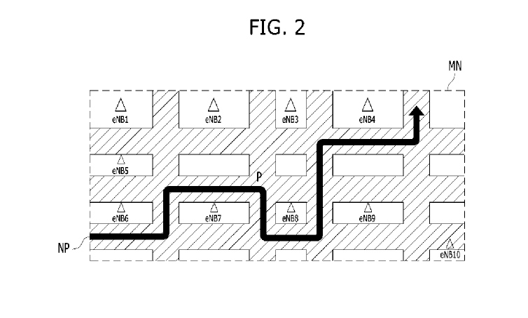

By virtue of a pre-sending operation of the estimated target eNB, data delay may occur during handover. A detailed operation of an AVN communication system 10 for a vehicle associated with the pre-sending request PS will be described with reference to FIGS. 2 to 5.

FIG. 2 is a diagram for explanation of the NPI and the position information PI_T of an estimated target eNB shown in FIG. 1.

FIGS. 1 and 2 illustrate a mini map MN to be displayed on a navigation program of the vehicle AVN 100.

The mini map MN is divided into a road (e.g., a slashed region) through which a vehicle passes and other regions.

Assuming that a navigation path (NP) through which a vehicle is to move is selected by a user, the vehicle AVN 100 generates NPI as information about the NP (e.g., information about a position of a start point, a path on a map, a position of a destination, and so on). The communication network provider server 300 may receive the NPI and generate the position information PI_T of an estimated target eNB as information about eNBs to be selected as a target eNB when the vehicle moves along the NP.

As shown in FIG. 2, eNBs positioned on the mini map MN include a first eNB eNB1 to a tenth eNB eNB10. Although eNBs are indicated on the MN for description of generation of the position information PI_T of the estimated target eNB, eNBs may not be indicated on a navigation program executed by the vehicle AVN 100.

The communication network provider server 300 may sequentially estimate a target eNB as a sixth eNB eNB6 to an eighth eNB eNB8 and the fourth eNB eNB4 using a position of each of the first eNB eNB1 to the tenth eNB eNB10 and the NP. With regard to estimation of the target eNB, the communication network provider server 300 may estimate the target eNB in consideration of a coverage radius of each eNB and a position of each of the first eNB eNB1 to the tenth eNB eNB10.

For example, when the vehicle moves along the NP, if handover between the sixth eNB eNB6 and the fifth eNB eNB5 is not necessary in consideration of a coverage radius of each of the sixth eNB and the seventh eNB eNB7 although a distance between the NP and the fifth eNB eNB5 is relatively short, the fifth eNB eNB5 may not be estimated as an estimated target eNB.

In the end, the communication network provider server 300 may generate position information PI_T of an estimated target eNB, as position information of each of the sixth eNB eNB6 to eighth eNB eNB8 and the fourth eNB eNB4.

Additionally, the communication network provider server 300 may generate the position information PI_T of an estimated target eNB, including position information of eNBs estimated as a next target eNB, based on the NPI and current position information of the vehicle. For example, the position information PI_T of the estimated target eNB, transmitted around a point P, may include position information of each of the eighth eNB eNB8 to the fourth eNB eNB4.

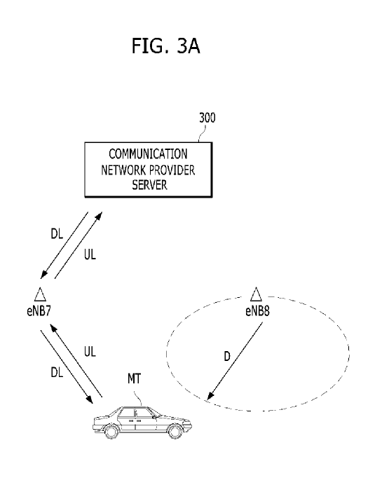

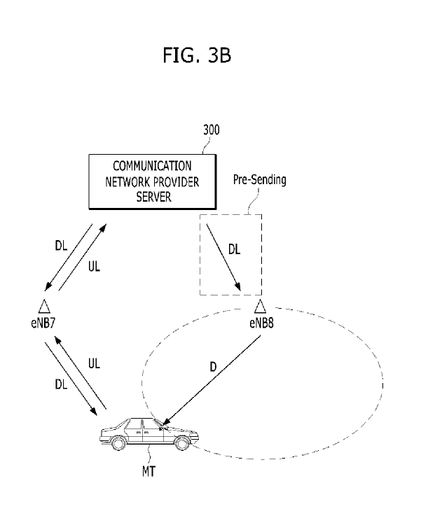

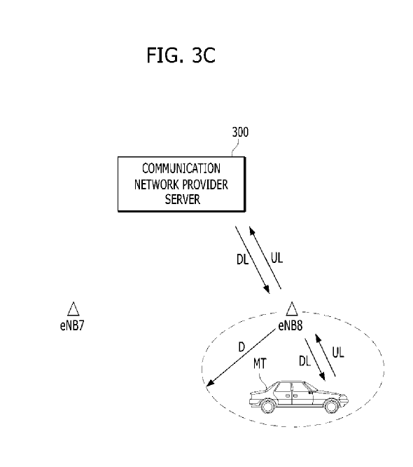

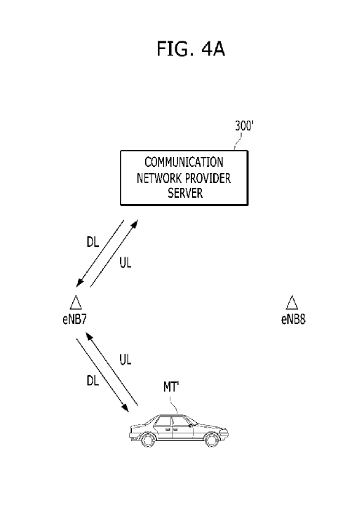

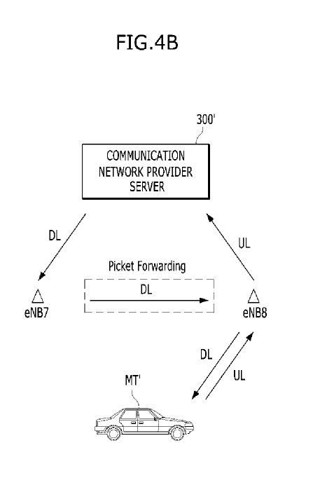

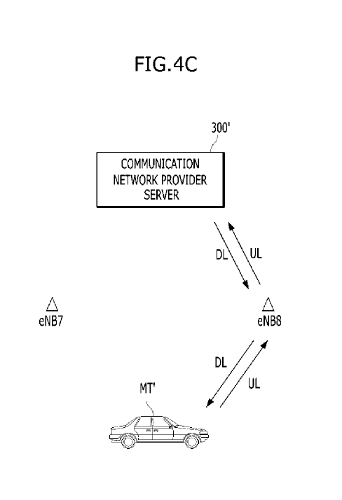

FIGS. 3A to 4C illustrate an operation of an AVN communication system 10 for a vehicle around the point P indicated in FIG. 2, in which a handover problem between the seventh eNB eNB7 and the eighth eNB eNB8 arises.

FIGS. 3A to 3C are diagrams for explanation of an operation of the AVN communication system 10 for a vehicle at the point P illustrated in FIG. 2 according to embodiments of the present disclosure.

Referring to FIGS. 1 to 3C, FIG. 3A illustrates a vehicle MT including the vehicle AVN 100 installed therein, which moves around the point P illustrated in FIG. 2. Assuming the seventh eNB eNB7 is currently a source eNB, the vehicle AVN 100 may transmit and receive download data DL and upload data UL to and from the communication network provider server 300 through the seventh eNB eNB7.

The vehicle AVN 100 may periodically generate a signal level report about whether data is smoothly transmitted and received to and from the seventh eNB eNB7 and transmit the signal level report to the communication network provider server 300.

The communication network provider server 300 may determine whether handover is required, based on the signal level report. That is, upon determining that the vehicle AVN 100 does not smoothly transmit and receive data based on the signal level report, the communication network provider server 300 may transmit a handover command for requesting handover to the vehicle AVN 100.

Upon receiving the handover command, the vehicle AVN 100 may calculate a first distance between the vehicle MT and the eighth eNB eNB8 estimated as the next target eNB based on the position information PI_T of the estimated target eNB. Additionally, the position information PI_T of the estimated target eNB may include position information of the fourth eNB eNB4 as well as the eighth eNB eNB8, but the vehicle AVN 100 may apply and store a priority order to each piece of eNB information in order to reduce computational load so as to calculate only the distance between the eighth eNB eNB8 and the vehicle MT.

The vehicle AVN 100 may compare the first distance and a threshold distance D. The threshold distance D is a preset distance according to a coverage radius of the eighth eNB eNB8 as the estimated target eNB. For example, the threshold distance D may be set to be relatively long compared with the eNB coverage radius in consideration of processing time of the pre-sending request PS, but the range of the present disclosure is not limited thereto. Coverage radiuses of the eNBs eNB1 to eNB10 may be the same or different.

In FIG. 3B, when the vehicle MT is continuously driven such that the first distance is smaller than the threshold distance D according to a comparison result between the first distance and the threshold distance D, the vehicle AVN 100 may transmit the pre-sending request PS to the communication network provider server 300. Furthermore, when the first distance is equal to the threshold distance D, that is, when the first distance is within the threshold distance D, the pre-sending request PS may be generated.

The communication network provider server 300 may perform a pre-sending operation for transmitting data DL being downloaded to the eighth eNB eNB8 as the estimated target eNB through the pre-sending request PS including information about the estimated target eNB and data DL being downloaded.

The vehicle AVN 100 may attempt synchronization with the eighth eNB eNB8 as the estimated target eNB and may test (or signal) whether data can be transmitted and received to and from the eighth eNB eNB8.

Upon completing synchronization with the eighth eNB eNB8 and determining that data can be stably transmitted and received, the vehicle AVN 100 may transmit a confirmation signal to the communication network provider server 300. Upon receiving the confirmation signal, the communication network provider server 300 may change a data path of the vehicle AVN 100 to the eighth eNB eNB8 from the seventh eNB eNB7.

In FIG. 3C, the vehicle MT is continuously driven such that the vehicle AVN 100 transmits and receives data to and from the communication network provider server 300 through the eighth eNB eNB8. In this case, since the eighth eNB eNB8 pre-receives the data DL being downloaded via the pre-sending operation, the vehicle AVN 100 may continuously receive the data DL being downloaded without data delay.

FIGS. 4A to 4C are diagrams for explanation of an operation of an AVN communication system for a vehicle around the point P illustrated in FIG. 2 according to a Comparative Example of the present disclosure.

Referring to FIGS. 1 to 4C, FIG. 4A illustrates a vehicle MT′ including a vehicle AVN installed therein, which moves around the point P illustrated in FIG. 2, like in FIG. 3A. In addition, assuming that the seventh eNB eNB7 is currently a source eNB, the vehicle AVN may transmit and receive download data DL and upload data UL to and from a communication network provider server 300′ through the seventh eNB eNB7.

The vehicle AVN may periodically generate a signal level report about whether data is smoothly transmitted and received to and from the seventh eNB eNB7 and transmit the signal level report to the communication network provider server 300′.

The communication network provider server 300′ may determine whether handover is required, based on the signal level report. That is, upon determining that the vehicle AVN 100 does not smoothly transmit and receive data based on the signal level report, the communication network provider server 300′ may transmit a handover command for requesting handover to the vehicle AVN and may be controlled to form a direct tunnel for transmission of the data DL being downloaded to the eighth eNB eNB8 from the seventh eNB eNB7.

In FIG. 4B, the seventh eNB eNB7 may perform a packet forwarding operation for transmitting the data DL being downloaded to the eighth eNB eNB8 through the direct tunnel formed between the eighth eNB eNB8 and the seventh eNB eNB7.

The vehicle AVN may attempt synchronization with the eighth eNB eNB8 according to the handover command and may test (or signal) whether data can be transmitted and received to and from the eighth eNB eNB8.

Upon completing synchronization with the eighth eNB eNB8 and determining that data can be stably transmitted and received, the vehicle AVN may transmit a confirmation signal to the communication network provider server 300′. Upon receiving the confirmation signal, the communication network provider server 300′ may change a data path of the vehicle AVN to the eighth eNB eNB8 from the seventh eNB eNB7.

However, during the packet forwarding operation, handover interrupt time (about 15 ms, for instance) in which the vehicle AVN cannot receive data from any eNB of the seventh eNB eNB7 and the eighth eNB eNB8 may occur. When the handover interrupt time accumulates, the quality of a data communication service is degraded.

In FIG. 4C, after the vehicle MT is continuously driven and the handover interrupt time elapses, the vehicle AVN may transmit and receive data to and from the communication network provider server 300′ through the eighth eNB eNB8.

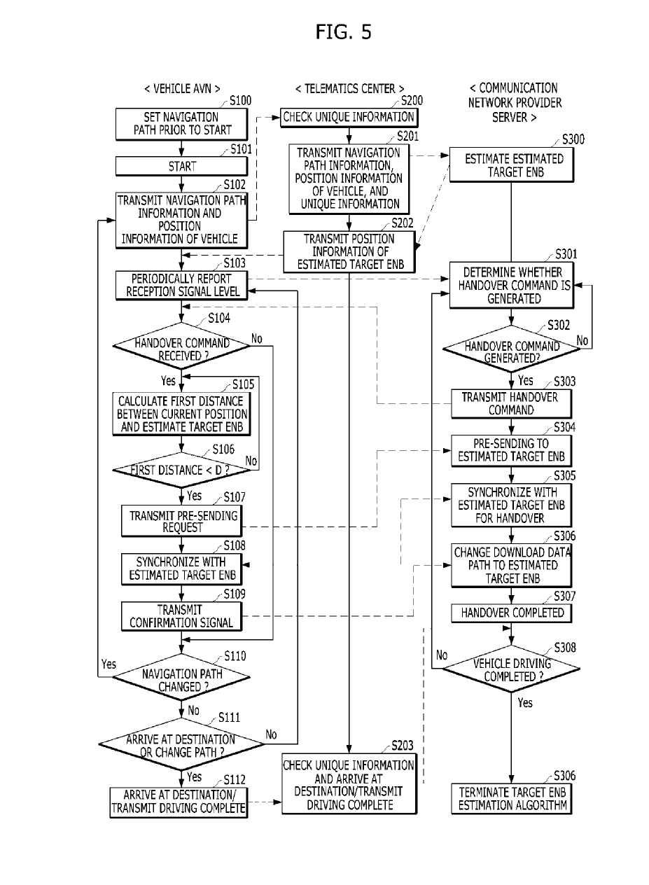

FIG. 5 is a flowchart for explanation of an operation of the vehicle AVN communication system 10 of FIG. 1.

Referring to FIGS. 1 to 5, the vehicle AVN 100 may set a navigation path NP determined according to user selection (S100).

The vehicle MT including the vehicle AVN 100 installed therein may start driving along the NP (S101).

The vehicle AVN 100 may transmit navigation path information NPI about the NP and current position information of the vehicle to the telematics center 200 (S102).

The telematics center 200 checks unique information of the vehicle AVN 100 that transmits the NPI about the NP and the vehicle position information (S200) and transmit the NPI and the vehicle position information to the communication network provider server 300 identified by the unique information (S201).

The communication network provider server 300 may determine the estimated target eNB estimated as the next target eNB based on the NPI and the vehicle position information and transmit the position information PI_T of the estimated target eNB to the telematics center 200 (S300). The telematics center 200 may transmit the position information PI_T of the estimated target eNB to the vehicle AVN 100 (S202).

The vehicle AVN 100 may periodically generate signal level report about whether data is smoothly transmitted and received to and from a source eNB and may transmit the signal level report to the communication network provider server 300 (S103).

The communication network provider server 300 may determine whether handover is required and a handover command is to be generated based on the signal level report (S301).

Upon determining that the vehicle AVN 100 cannot smoothly transmit and receive data based on the signal level report (i.e., Yes at S302), the communication network provider server 300 may transmit a handover command for requesting handover to the vehicle AVN 100 (S303).

Upon determining that the vehicle AVN 100 smoothly transmits and receive data to and from the signal level report (i.e., No at S302), the communication network provider server 300 may re-perform operation S301.

Upon receiving the handover command (i.e., Yes at S104), the vehicle AVN 100 may calculate the first distance between the vehicle MT and estimated target eNB from the position information PI_T of the estimated target eNB (S105).

When the vehicle AVN 100 does not receive the handover command (i.e., No at S104), operation S110 to be described below is performed.

The vehicle AVN 100 may compare the first distance and the threshold distance D. According to the comparison result between the first distance and the threshold distance D, when the first distance is smaller than the threshold distance D (i.e., Yes at S106), the vehicle AVN 100 may transmit the pre-sending request PS to the communication network provider server 300 (S107).

According to the comparison result between the first distance and the threshold distance D, when the first distance is not smaller than the threshold distance D (i.e., No at S106), the vehicle AVN 100 may periodically (e.g., every 100 ms) calculate the first distance and may compare the first distance with the threshold distance D (S105).

The communication network provider server 300 may perform a pre-sending operation for transmitting data DL being downloaded to the estimated target eNB through the pre-sending request PS including information about the estimated target eNB and data DL being downloaded (S304).

The vehicle AVN 100 and the estimated target eNB may attempt synchronization with each other and may test (or signal) whether data can be transmitted and received to and from each other (S108 and S305).

Upon completing synchronization with the estimated target eNB and determining that data can be stably transmitted and received, the vehicle AVN 100 may transmit a confirmation signal to the communication network provider server 300 (S109).

Upon receiving the confirmation signal, the communication network provider server 300 may change a data path of the vehicle AVN 100 to the estimated target eNB from the source eNB (S306) and may complete the handover (S307).

When the navigation path NP is changed by a user (i.e., Yes at S110), the vehicle AVN 100 may transmit navigation path information NPI about a new navigation path NP and current position information of the vehicle to the telematics center 200 (S102) and may re-perform subsequent operations.

When the NP is not changed by the user (i.e., No at S110), the vehicle AVN 100 may re-perform operation S103 when the vehicle MT has not arrived at a destination and has not completed driving (i.e., No at S111).

When the vehicle MT arrives at a destination or completes driving (i.e., Yes at S111), the vehicle AVN 100 may transmit destination arrival and driving complete signals to the telematics center 200 (S112).

The telematics center 200 may check unique information of the vehicle AVN 100 that transmits the destination arrival and driving complete signals and transmit the destination arrival and driving complete signals to the communication network provider server 300 identified through the unique information (S203).

When the handover operation is completed and the communication network provider server 300 cannot receive the destination arrival and driving complete signals (i.e., No at S308), operation S301 is re-performed.

When the handover operation is completed and the communication network provider server 300 receives the destination arrival and driving complete signals (Yes of S308), the communication network provider server 300 may terminate a target eNB estimation algorithm, that is, an algorithm for target eNB estimation and data transmission without delay based on an the NPI (S309).

Accordingly, the vehicle AVN communication system according to embodiments of the present disclosure may perform a pre-sending operation on a target eNB based on the NPI such that the vehicle MT that moves rapidly can perform data communication without data delay. The aforementioned vehicle AVN communication system according to the present disclosure may perform a pre-sending operation on a target eNB based on navigation path information such that a rapidly moving vehicle can perform data communication without data delay.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A wireless communication method for an audio-video-navigation (AVN) device of a vehicle using a mobile communication network, the method comprising:
receiving position information of an estimated target base station, which is estimated based on navigation path information;
receiving a handover command;
comparing the position information of the estimated target base station to position information of the AVN device of the vehicle upon receiving the handover command;
determining whether a first distance from the estimated target base station to the AVN device of the vehicle is within a threshold distance;
requesting pre-sending with respect to the estimated target base station when the first distance is within the threshold distance;
synchronizing with the estimated target base station; and
generating a confirmation signal in response to the handover command.

2. The method according to claim 1, wherein a target of the pre-sending is data being currently downloaded by the AVN device of the vehicle.

3. The method according to claim 2, further comprising continuously downloading the data being currently downloaded from the estimated target base station after generating the confirmation signal.

4. The method according to claim 1, further comprising, when a navigation path has changed, receiving position information of the estimated target base station based on the changed navigation path.

5. The method according to claim 1, wherein the threshold distance is preset according to a change in radius of the estimated target base station.

6. A wireless communication method for an audio-video-navigation (AVN) device of a vehicle using a mobile communication network, the method comprising:
estimating, by a communication network provider server, position information of an estimated target base station based on navigation path information of the AVN device of the vehicle;
generating, by the communication network provider server, a handover command using a signal level report of the AVN device of the vehicle;
comparing, by the AVN device of the vehicle, the position information of the estimated target base station to position information of the AVN device of the vehicle upon receiving the handover command;
determining, by the AVN device of the vehicle, whether a first distance from the estimated target base station to the AVN device of the vehicle is within a threshold distance;
requesting, by the AVN device of the vehicle, pre-sending with respect to the estimated target base station when the first distance is within the threshold distance;
synchronizing, by the AVN device of the vehicle, with the estimated target base station; and
generating, by the AVN device of the vehicle, a confirmation signal in response to the handover command.

7. The method according to claim 6, wherein a target of the pre-sending is data being currently downloaded by the AVN device of the vehicle.

8. The method according to claim 7, further comprising:
changing, by the communication network provider server, a download data path of the AVN device of the vehicle to the estimated target base station upon receiving the confirmation signal; and
continuously downloading, by the AVN device of the vehicle, the data being currently downloaded from the estimated target base station.

9. The method according to claim 6, further comprising performing, by the communication network provider server, pre-sending on the estimated target base station corresponding to the request.

10. The method according to claim 6, further comprising identifying, by a telematics center, the communication network provider server corresponding to the AVN device of the vehicle using unique information of the AVN device of the vehicle; and
transmitting, by the telematics center, the navigation path information and the unique information to the communication network provider server.

11. The method according to claim 6, further comprising, when a navigation path has changed, receiving, at the AVN device of the vehicle, position information of the estimated target base station estimated based on the changed navigation path.

12. The method according to claim 6, wherein the threshold distance is preset according to a change in radius of the estimated target base station.

13. An audio-video-navigation (AVN) communication system for a vehicle using a mobile communication network, the system comprising:
a communication network provider server i) estimating position information of an estimated target base station based on navigation path information and ii) generating a handover command using a signal level report; and
an AVN device of the vehicle i) comparing the position information of the estimated target base station to position information of the AVN device of the vehicle upon receiving the handover command, ii) determining whether a first distance from the estimated target base station to the AVN device of the vehicle is within a threshold distance, iii) requesting pre-sending with respect to the estimated target base station when the first distance is within the threshold distance, iv) synchronizing with the estimated target base station, and v) generating a confirmation signal in response to the handover command.

14. The system according to claim 13, wherein a target of the pre-sending is data being currently downloaded by the AVN device of the vehicle.

15. The system according to claim 14, wherein the communication network provider server changes a download data path of the AVN device of the vehicle to the estimated target base station and continuously downloads the data being currently downloaded from the estimated target base station, upon receiving the confirmation signal.

16. The system according to claim 13, wherein the communication network provider server performs pre-sending on the estimated target base station corresponding to the request.

17. The system according to claim 13, further comprising a telematics center identifying the communication network provider server corresponding to the AVN device of the vehicle using unique information of the AVN device of the vehicle and transmitting the navigation path information and the unique information to the communication network provider server.

18. The system according to claim 13, wherein, when a navigation path is changed, the AVN device of the vehicle receives position information of an estimated target base station estimated based on the changed navigation path.

19. The system according to claim 13, wherein the threshold distance is preset according to a change in radius of the estimated target base station.
